(19) United States
(12) Patent Application Publication
(10) Pub. No.: US 2015/0029946 A1
(43) Pub. Date: Jan. 29, 2015

(54) MODULATION OF PACKET CHARACTERISTICS TO ESTABLISH AN OVERLAY COMMUNICATION CHANNEL

(71) Applicant: Michael Edward Smith Luna, San Jose, CA (US)

(72) Inventor: Michael Edward Smith Luna, San Jose, CA (US)

(21) Appl. No.: 13/952,552

(22) Filed: Jul. 26, 2013

(51) Int. Cl. H04L 29/06

(52) U.S. Cl. CPC H04L 69/22
USPC 370/329

(57) ABSTRACT

Embodiments relate generally to electrical and electronic hardware, computer software, wired and wireless network communications, electronic media presentation of audio and video, and wearable/mobile computing devices configured to facilitate communication among electronic devices, including mobile phones and media devices that present audio and/or video content. More specifically, disclosed are systems, components and methods to establish an overlay communication channel based on modulating and demodulating packet characteristics. In various embodiments, a packet characteristic modulator or demodulator can be disposed in a first device to establish at least a unidirectional communication link to autonomously discover suitable electronic devices, such as a second device, with which to collaborate. In one embodiment, a packet characteristic demodulator can be configured to acquire packet characteristic values to determine message data. A packet characteristic value corresponds to a symbol. The packets can be demodulated as a function of the packet characteristic values to form extracted symbols.

### CROSS-REFERENCE TO RELATED APPLICATIONS

This application is co-related to U.S. Nonprovisional patent application Ser. No. 13/______, filed ______ with Attorney Docket No. ALI-234, and entitled “AUTONOMOUS DEVICE DISCOVERY USING ENCODED PACKETS,” which is herein incorporated by reference in its entirety and for all purposes.

### FIELD

Embodiments relate generally to electrical and electronic hardware, computer software, wired and wireless network communications, electronic media presentation of audio and video, and wearable/mobile computing devices configured to facilitate communication among electronic devices, including mobile phones and media devices that present audio and/or video content. More specifically, disclosed are systems, components and methods that modulate and demodulate packet characteristics to establish an overlay communication channel.

### BACKGROUND

Collaboration among conventional electronics devices has increased with incremental improvements in computational resources and mobile communication abilities. However, modern security requirements for encrypted data and present network communication specifications, among other things, generally impede the user's ability to configure various electronic devices to collaborate with each other. Examples of traditional electronic devices for which collaboration is desired includes mobile telephones, mobile computing device, and media devices, such as speakers, televisions, tablets, and any other audiovisual equipment.

Typically, a user is required to configure communication accessibility of a new electronic device so that it communicates with other electronic devices, such as a user's mobile phone or network element, such as a wireless router or access point. For example, consider that a user receives an electronic device as a gift and knows little of the manufacturer and the configurability of the device. Should the user desire that the new device interact with other electronic devices, the user normally provides authorization by, for example, entering a login and password to an access point. Once configured, the user's devices might access each other through the access point. Furthermore, consider that a friend of the user visits and/or comes into close proximity to the new device and wishes a personal device to communicate with the new device. In this case, the friend likely does not know the authorization information for the access point, and thus will not be able to have its personal device collaborate with the new device. Such impediments in conventional device collaboration tend to diminish users' experience in consuming audio and video content.

While functional, traditional devices and solutions to device collaboration are not well-suited for providing autonomous connectivity among one or more electronic devices.

Thus, what is needed is a solution for facilitating device collaboration without the limitations of conventional techniques.

### BRIEF DESCRIPTION OF THE DRAWINGS

Various embodiments or examples (“examples”) of the invention are disclosed in the following detailed description and the accompanying drawings:

FIG. 1 illustrates an example of an overlay communication channel, according to some embodiments;

FIG. 2 illustrates an example of a packet characteristic modulator, according to some embodiments;

FIG. 3 illustrates an example of a packet transformer, according to some embodiments;

FIG. 4 illustrates an example of the operation of an overlay communication channel, according to some embodiment;

FIG. 5 illustrates an example of deriving message data from packets received from an overlay communication channel, according to some embodiments;

FIGS. 6A and 6B illustrate various functionalities of a media processor, according to some embodiments;

FIGS. 7A and 7B illustrate examples of modulating and demodulating packets and associated data, according to some embodiments; and

FIG. 8 illustrates an exemplary computing platform disposed in a device in accordance with various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

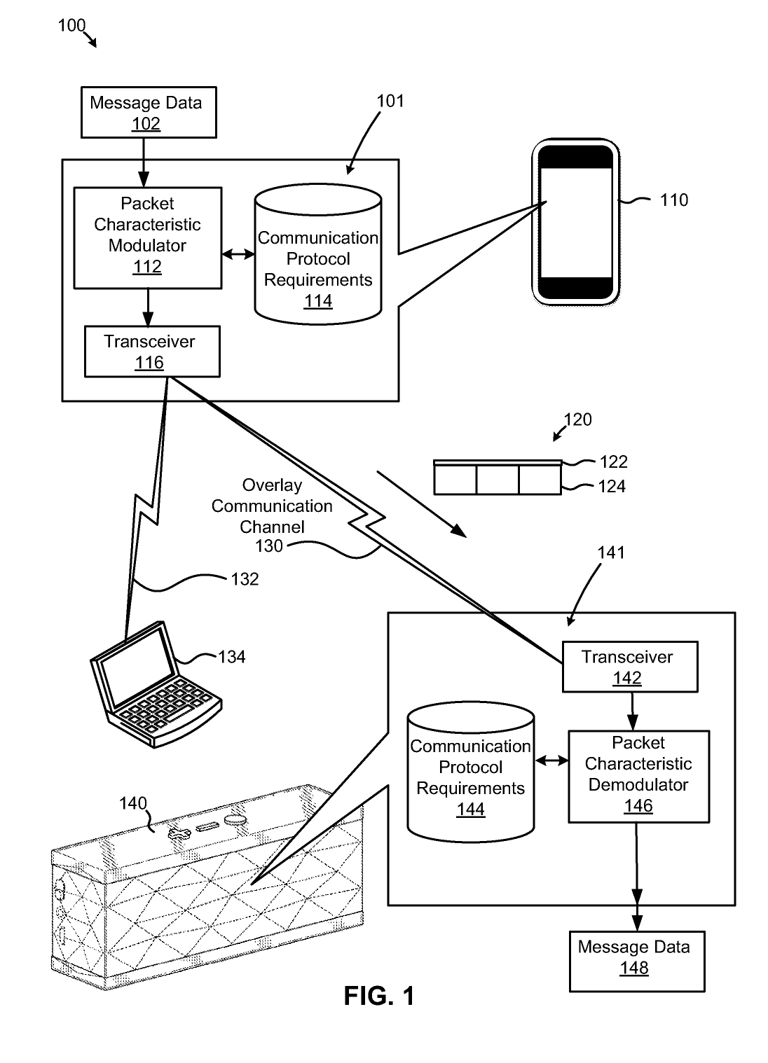

FIG. 1 illustrates an example of an overlay communication channel, according to some embodiments. Diagram 100 depicts a first group 101 of elements and a second group 141 of elements configured to establish overlay communication channel 130. As shown, first group 101 of elements is disposed in a mobile computing device 110, and includes a packet characteristic modulator 112, a repository including data 114 representing communication protocol requirements, and a transceiver 116 (e.g., a transmitter and/or receiver). Further, second group 141 of elements is shown to be disposed in a media device 140, and includes a transceiver 142, a packet characteristic demodulator 146, and a repository including data 144 representing communication protocol requirements.

Packet characteristic modulator 112 is configured to modulate at least one packet characteristic of packets transmitted via transceiver 116 to include encoded symbols based on message data 102. For example, packet characteristic modulator 112 can modulate a packet characteristic as a function of a value associated with a symbol from message data 102. Examples of symbols include characters, text, letters, numbers, control characters, ASCII characters, and the like. Therefore, packet characteristic modulator 112 can modulate a characteristic of a packet 124 to include a modified packet characteristic. In the example shown, the modified packet characteristic is overlaid upon, embedded in, or otherwise associated with protocol packet 124, whereby a transformed packet 120 includes protocol packet 124 and its modified packet characteristic 122. In some examples, overlay communication channel 130 is composed of a number of modified packet characteristics 122 overlaid upon a stream of protocol packets 124.

Packet characteristic demodulator 146 is configured to detect (e.g., “sniff”) transformed packets 120 and to extract such packets from a stream of packets that includes other packets. Packet characteristic demodulator 146 is configured to obtain or acquire packet characteristic values, each of which corresponds to a symbol. Also, packet characteristic demodulator 146 is configured to identify a characteristic of transformed packet 120 subject to modulation, and demodulate the characteristic to extract a symbol therefrom. Further, packet characteristic demodulator 146 is configured to assemble the demodulated packets to form message data 148. In the example shown, message data 148 can include data adapted for use by media device 140 to perform, for example, a media-related operation, such as presenting audio and/or visual imagery.

As used herein, the term “overlay communication channel” can refer to, at least in some embodiments, a parasitic data communications channel overlaid upon (e.g., piggybacked upon), embedded in, or otherwise associated with a principal communication channel typically composed of a stream of networking protocol packets configured to travel between two or more network connections. The networking protocol packets can be specified by various known protocols and protocol stacks. In some examples, packet characteristic modulator 112 can establish or otherwise implement protocol packet 124 to specifically convey modified packet characteristic data 122. In other examples, packet characters modulator 112 can implement modified packet characteristic data 122 in connection with protocol packets 124 that are intended for another use. To illustrate, consider that device 110 is generating protocol packets 124 destined for computing device 134 via communication channel 132. Therefore, payload data of protocol packets 124 can be encrypted and can have a specific use other than communicating data from device 110 to device 140. Modified packet characteristic data 122 can therefore parasitically communicate to device 140 based on protocol packets 124 bound for device 134. Thus, transceiver 142 can receive these packets, and packet characteristic demodulator 146 can extract symbols from modified packet characteristic data 122, regardless of the payload of protocol packet 124. In various embodiments, overlay communication channel 130 can be a direct packet-based communication link, or overlay communication channel 130 can couple between any number of devices (e.g., a wireless access point) between devices 110 and 140. Examples of communication links that provide for direct communication include Bluetooth®, Wi-Fi Direct™, and other like specifications.

In view of the foregoing, the functions and/or structures of either packet characteristic modulator 112 or packet characteristic demodulator 146, or both, can provide for the formation of overlay communication channel 130, which, in turn, can facilitate electronic device collaboration. Electronic device collaboration includes, but is not limited to, autonomous discovery of an electronic device, such as the autonomous discovery of device 140. In some embodiments, overlay communication channel 130 can be a unidirectional communication link from device 110 to device 140, whereby the unidirectional communication link can be formed independent of authorization data that establishes a session between device 110 and 140 device. Further, packet characteristic modulator 112 and packet characteristic demodulator 146 can be configured to modulate and to demodulate, respectively, accessible packet characteristics. An accessible packet characteristic is publicly accessible or non-encrypted (i.e., not subject to encryption)—regardless of whether the payload or the packet is encrypted in accordance with protocol specifications, such as set forth in protocol stacks. Thus, packet characteristic modulator 112 and packet characteristic demodulator 146 can establish a communication link to discover suitable electronic devices, such as device 140, with which to collaborate. Such discovery can occur with negligible to no delays imposed by authentication processes and/or encrypted packet data.

By modulating and demodulating accessible packet characteristics, at least in some embodiments, device 110 can autonomously discover device 140 at a point in time at which neither device 110 nor device 140 include data about the other (i.e., devices 110 and 140 were not connected to each other up until the point in time at which autonomous discovery is initiated). Therefore, device 140 can receive or otherwise “learn” or become “aware” about device 110 and its data (i.e., personal data). Examples of such learned data include a playlist, audio files, login identifiers, passwords, and the like. Thus, device 140 can obtain this data autonomously without requiring device 110 or its user to upload or otherwise pass along such data. To illustrate, consider that user of device 110 visits a friend who recently purchased device 140, which is a media device capable of presenting audio and/or video. The user of device 110 does not know login IDs or passwords for the friend's electronic devices, including device 140, access points, network elements, such as routers, or other networked devices. Without such information, or the overlay communication channel 130 described herein, user of device 110 likely cannot hand-off control of media playback to device 140. But with implementation overlay communication channel 130, device 110 can autonomously hand-off control of, for example, the streaming of music from the Internet to device 140 by passing along message data that facilitates music streaming (e.g., login information, passwords, and playlists for third party music-serving entities). Furthermore, overlay communication channel 130 can be parasitic in nature, and, thus, can be transmitted in association with packets bound for other devices, thereby forgoing a requirement to generate packets, at least in some cases, that are specifically designed to transport modified packet characteristic data 122. In some cases, this may reduce computational resource requirements and data packet traffic over a local network.

Transceivers can be implemented as either transmitters or receivers, or both, and can provide communication channels over any network (e.g., any data network), such as IP networks, Bluetooth® networks, cellular networks, etc. Further, memory repositories including data 114 and data 144, which represent communication protocol requirements, can be used as, or in cooperation with, protocol stacks. The protocol stacks include protocol specifications from low-level OSI layers (e.g., physical layer) up through high-level OSI layers (e.g., application layer), the protocol specification (or equivalents) can provide for definitions of packet characteristic that can be modulated and demodulated, according to various examples described herein. Data 114 and data 144 can include communication protocol requirements to implement a variety of protocols, such as Internet Protocols (e.g., TCIP/IP protocol stacks) including Internet Control Message Protocol (“ICMP”) and the like, Ping protocols (e.g., “echo reply” ICMP), ARP-related protocols, Bluetooth® protocols and protocol stacks, security protocols (e.g., SSL, HTTPS, etc.), Simple Mail Transfer Protocol (“SMTP”), and the like.

According to at least some examples, packet characteristic modulator 112 and/or packet characteristic demodulator 146 can facilitate the use of modulating and demodulating, respectively, packet characteristics of ping protocol packets 124 to form overlay communication channel 130. In one example, packet characteristic modulator 112 and packet characteristic demodulator 146 can be configured to modulate and demodulate, respectively, packet characteristics by modifying packet lengths of the packets. Any type and/or number of different types of packet characteristics may be modulated or demodulated, according to various embodiments to encode and decode one or more symbols in one or more packets.

An example of media device 140, as well as examples of its components or elements, can include those components used to receive communication data, are disclosed in U.S. patent application Ser. No. 13/831,422, entitled “Proximity-Based Control of Media Devices,” filed on Mar. 14, 2013 with Attorney Docket No. ALI-229, which is incorporated herein by reference. In various examples, media device 202 is not limited to presenting audio, but rather can present both visual information, including video (e.g., using a pico-projector digital video projector or the like) or other forms of imagery along with (e.g., synchronized with) audio. At least some components of media device 140 can be implemented similarly as Jambox® products produced by AliphCom, Inc., of California.

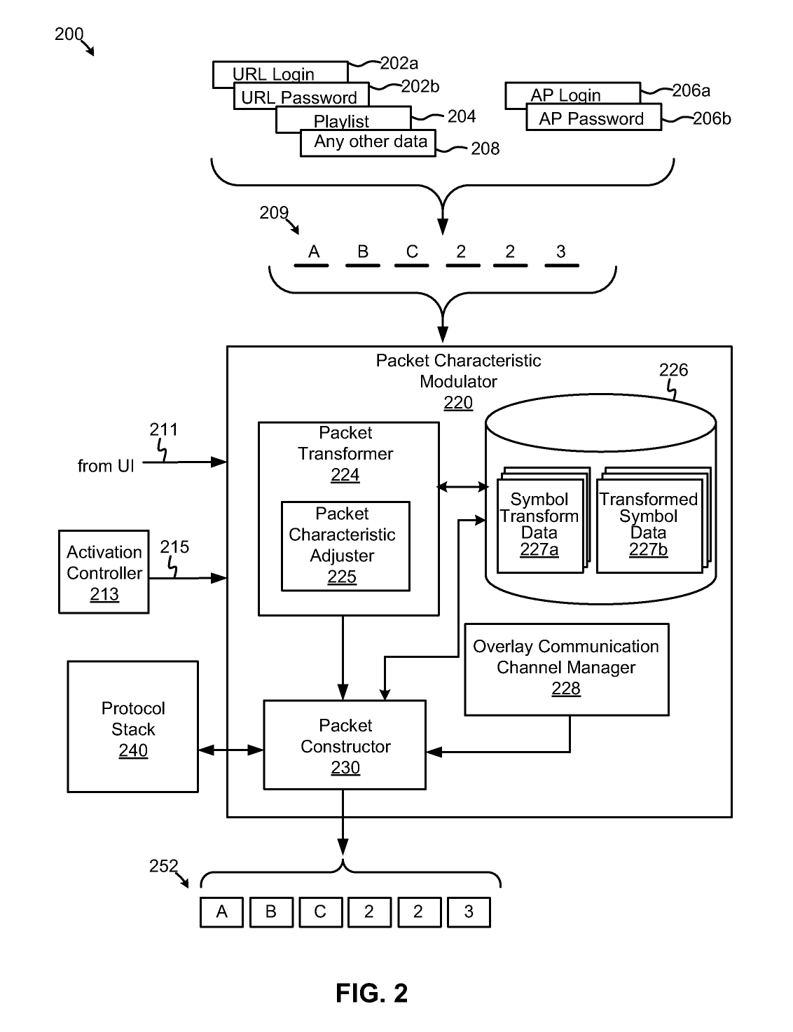

FIG. 2 illustrates an example of a packet characteristic modulator, according to some embodiments. Diagram 200 depicts an example of a packet characteristic modulator 220 that includes a packet transformer 224, a repository 226, which can include symbol transform data 227a and/or transformed symbol data 227b, an overlay communication channel manager 228, and a packet constructor 230. Packet characteristic modulator 220 is configured to receive symbols 209, and is further configured to modulate packet characteristics to encode symbols 209 into packets depicted in packet stream 252. In some embodiments, packet characteristic modulator 220 is configured to receive an instruction to transmit transformed packets including message data composed of symbols 209 to form an overlay communication channel. The instruction can be transmitted as signal 211, which can originate from a user interface (“UI”) (e.g., responsive to an input from a user to establish the overlay communication channel to discover unknown compatible devices). Or, an activation controller 213 can generate an instruction signal 215 responsive to, for example, the expiration of a periodic or aperiodic timer (e.g., packet characteristic modulator 220 can, from time-to-time, automatically search for collaborative devices). In some cases, activation controller 213 can generate instruction signal 215 responsive to detection of radio frequency signals from devices that may be able to demodulate packets of packet stream 252. In some example, instruction signals 213 and/or 215 can include data representing a password and an operation to initiate presentation of audio and/or video at the receiving device.

In the example shown, message data can include symbols 209 that constitute one or more of a URL login 202a, a URL password 202b, a playlist 204 (e.g., data representing a list of audio tracks, sounds, or songs), an access point (“AP”) login 206a, an access point (“AP”) password 206b, and/or any other data 208. Packet transformer 224 can be configured to perform or control transformation of protocol packets, and their characteristics, so that the packets include data representing encoded symbols 209. Packet transformer 224 can acquire packet characteristic values used to encode symbols 209 of the message data from, for example, repository 226, whereby each packet characteristic value corresponds to a unique symbol. In some embodiments, specific symbols 209 are predetermined prior to the construction of transformed packets for transmission as packet stream 252. In this case, predetermined transformed symbol data 227b can be acquired by packet transformer 224 to modify packet characteristics. Transformed symbol data 227b can include a data arrangement of packet characteristic values ordered similar to the order of symbols 209. Packet characteristic values, and the order thereof, for modulating packets is thus predetermined (i.e., packet characteristic values need not be calculated on-the-fly). In alternate embodiments, symbols 209 are not predetermined and, for example, can be supplied by a user via a user interface (e.g., on-the-fly). In this case, packet transformer 224 can be configured to identify a symbol 209, perform a look-up (or some other transformation operation) in connection with symbol transform data 227a, and retrieve a corresponding packet characteristic value from symbol transform data 227a.

Packet transformer 224 is shown to include a packet characteristic adjuster 225 that is configured to adjust a value of a packet characteristic as a function of packet characteristic values retrieved from repository 226. The value can be adjusted during packet construction performed by packet constructor 230, which can be coupled to a protocol stack 240 and to an overlay communications manager 228. Protocol stack 240, for example, can be configured to provide network protocol specifications or definitions to packet constructor 230 for constructing transformed packets in accordance with operation of a packet protocol (e.g., a ping protocol). Accordingly, packet characteristic adjuster 225 can be configured to modulate (or control modulation of) a characteristic of packets specified by a network protocol of protocol stack 240 as a function of the packet characteristic values. Responsive to packet characteristic values provided by packet characteristic adjuster to 225, packet constructor 230 forms transformed packets of packet stream 252. A transformed packet can be a protocol packet, such as a ping packet, configured to include a modified packet characteristic that encodes a symbol into, or in relation to, a corresponding packet. In some examples, overlay communications manager 228 is optional. Overlay communications manager 228, at least in some embodiments, can manage the transmission of transformed packets via the overlay communication channel to maintain an order set forth by symbols 209. In some embodiments, overlay communications manager 228 is configured to implement, insert, or otherwise provide transformed packets into packet stream 252. The inserted packets may include modified packet characteristics that specify one or more of a command (e.g., a command identifier indicating subsequent transformed packets include a command), application data (e.g., an application identifier indicating subsequent transformed packets include application data), and overlay checksum specifying a checksum of multiple values of modified packet characteristic (to confirm accurate data transmission), and/or the like. This information may be used to facilitate demodulation at a recipient device.

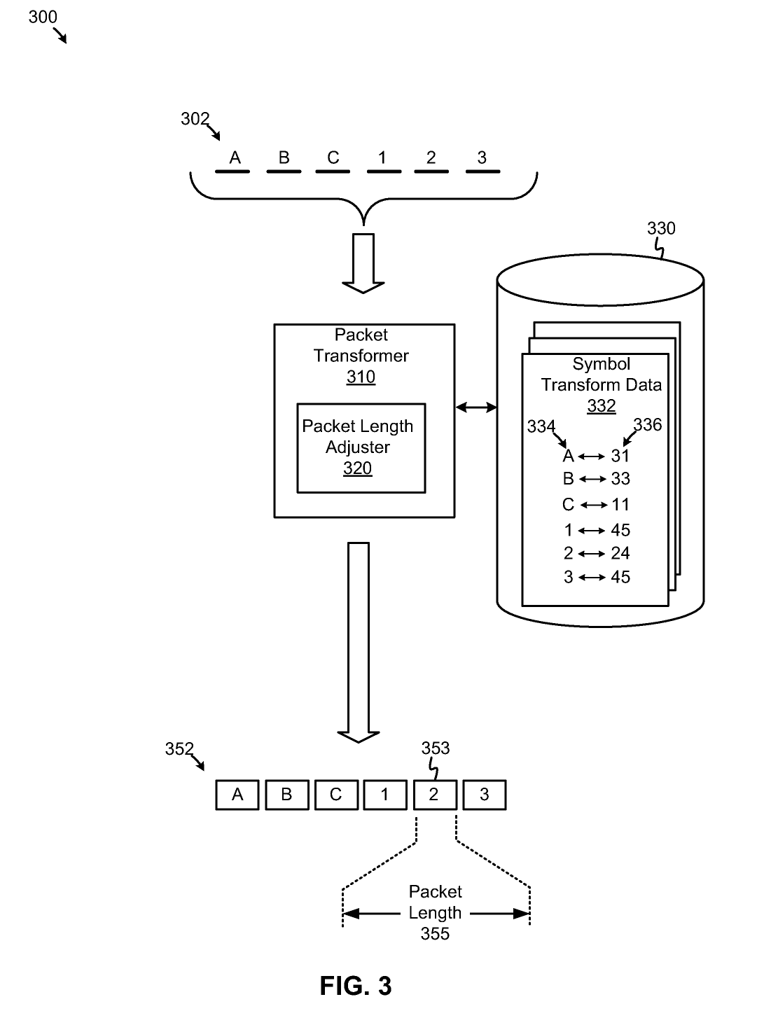

FIG. 3 illustrates an example of a packet transformer, according to some embodiments. Diagram 300 depicts an example of a packet transformer 310 that includes a packet characteristic adjuster implemented as a packet length adjuster 320. Packet characteristic transformer 310 is configured to receive symbols 302, and is further configured to modulate packet characteristics to encode symbols 302 with packets, such as packet 353, of packet stream 352. Diagram 300 also depicts a repository 330 including symbol transform data 332, which includes data representing associations between specific symbols 334 and corresponding packet characteristic values 336. As shown, symbol or letter “A” is associated with the packet characteristic of “31.” According to the example shown, packet characteristic values 336 each describe different packet lengths with which to modify or adjust packet lengths to encode a corresponding symbol 334 into a packet 353. Packet length adjuster 320 is configured to modify packet lengths of packets, such as packet length 355 of packet 353, in accordance with symbol transform data 332. In this case, symbol “2” is shown to be associated with a packet length of 24. Therefore, transformed packet 353 has a packet length modified or adjusted to include a packet length of 24, which is a packet characteristic value that corresponds to symbol “2” embedded into transformed packet 353. In some cases, a field in packet 353 includes data representing the packet length, which can be publicly accessed for modification.

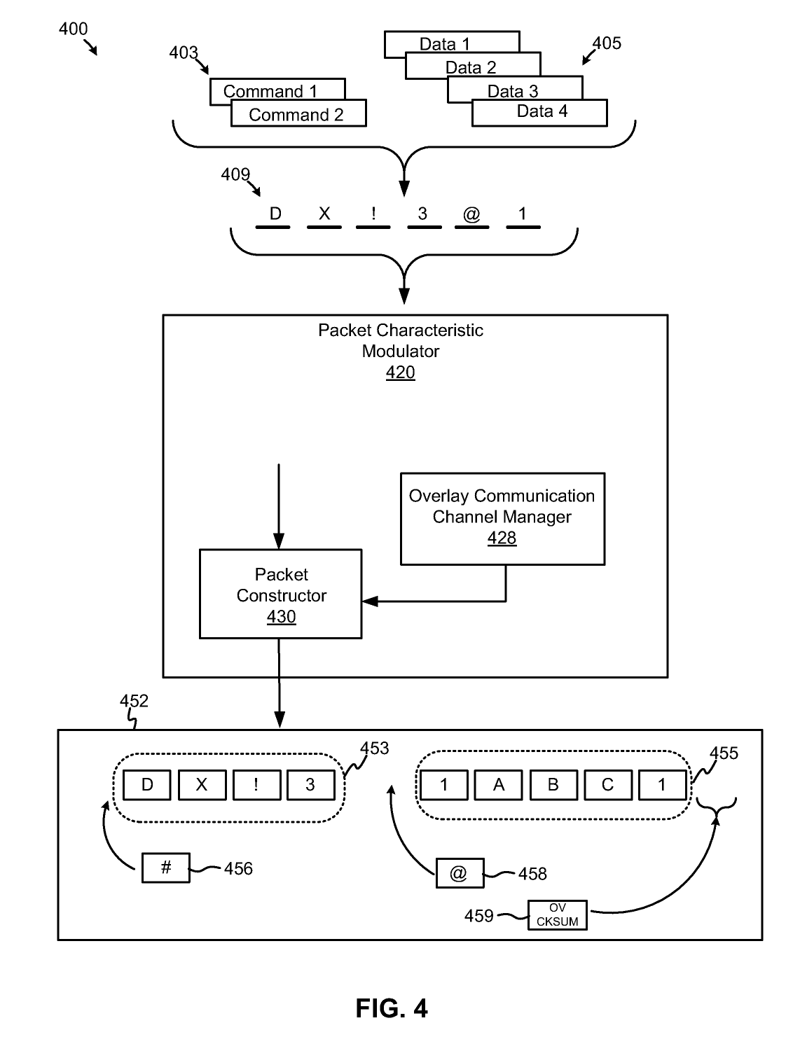

FIG. 4 illustrates an example of the operation of an overlay communication channel, according to some embodiments. Diagram 400 depicts an example of a packet characteristic modulator 420 including a packet constructor 430 and an overlay communication channel 428. In this example, packet characteristic modulator 420 is configured to receive symbols 409 from commands 403 (e.g., opcodes and the like) and data 405 (e.g., application data). In some embodiments, overlay communications manager 428 is configured to implement, insert, or otherwise provide a transformed packet 456 into packet stream 452. An inserted packet can include modified packet characteristics specifying a command. In particular, overlay communications manager 428 can insert a command identifier (“#”) 456 indicating that subsequent transformed packets 453 include a command. Also, overlay communications manager 428 can insert an application data identifier (“@”) 458 indicating that subsequent transformed packets 455 include application data (e.g., data representing audio). Further, overlay communications manager 428 can insert an overlay checksum (“OV CKSUM”) 458 specifying a checksum of multiple values of modified packet characteristic (to confirm accurate data transmission). A receiving device can be configured to decode command identifier 456, application data identifier 458, overlay checksum 458, and the like, to facilitate device collaboration via an overlay communication channel.

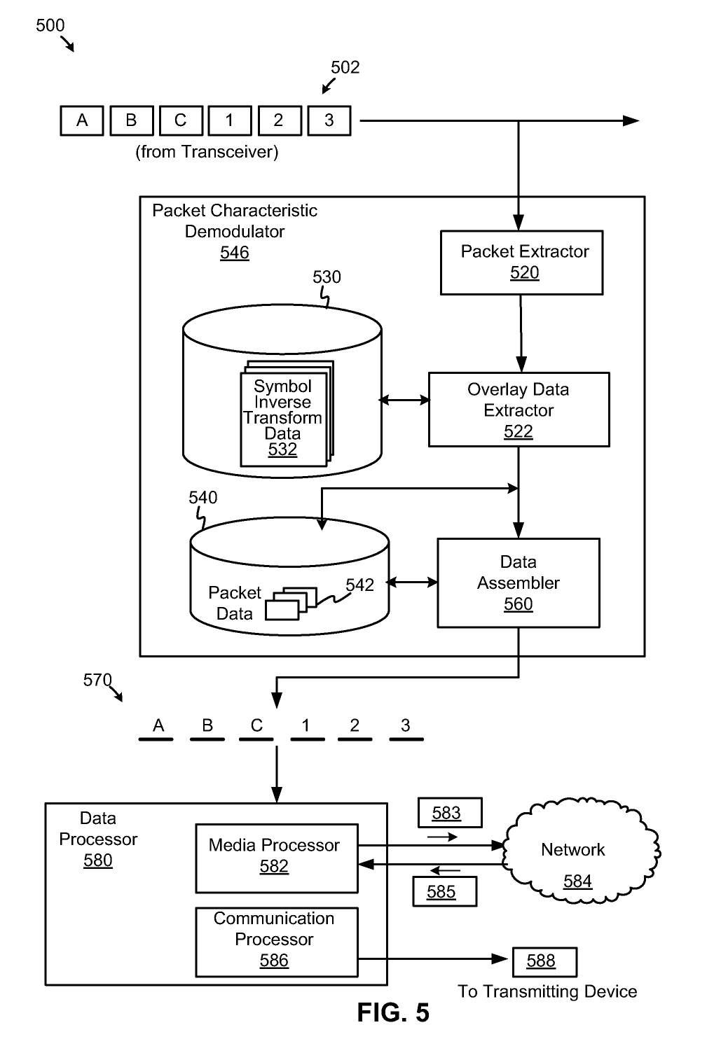

FIG. 5 illustrates an example of deriving message data from packets received from an overlay communication channel, according to some embodiments. Diagram 500 depicts an example of a packet characteristic modulator 546 that includes a packet extractor 520, an overlay data extractor 522, a repository 530 configured to store data representing symbol inverse transform data 532, an optional repository 540 configured to store packet data 542, and a data assembler 560. A group 502 of packets is received from a transceiver, whereby the packets include modulated packet characteristics that include encoded symbol data. In some examples, the packets of group 502 can originate from a second device that is broadcasting the packets as transformed packets. Packet extractor 520 is configured to extract a subset of packets that include group 502 from a packet stream. In operation, packet extractor 520 can function to “sniff” packets or otherwise monitor packets from the transceiver (e.g., using Wi-Fi monitor modes, Radio Frequency Monitor mode, etc.) to identify and extract packets of interest. In some cases, certain protocol packets (e.g., ping packets) can be extracted to test whether the packet characteristics provide coherent and valid message data rather than random data (e.g., of an intended ping operation).

Overlay data extractor 522 is configured to identify characteristic of the packets as specified by a network protocol, such as packet length as a packet characteristic. Further, overlay data extractor 522 can be configured to acquire packet characteristic values from symbol inverse transform data 532, which provides for an inverse transformation of the transformed packets received into packet characteristic demodulator 546. Packet characteristic values in symbol inverse transform data 532 correspond to, or are associated with, a symbol. Overlay data extractor 522 is configured to demodulate transformed packets as a function of the packet characteristic values (i.e., overlay data extractor 522 can identify modified packet characteristics, and extract or otherwise decode the packet characteristics to obtain symbols therefrom.). In some examples, overlay data extractor 522 is configured to demodulate characteristics of the packets by identifying packet lengths of the packets. In this case, the packet lengths are the packet characteristic values. Overlay data extractor 522 can decode the packet lengths to form extracted symbols.

Data assembler 560 is configured to assemble a message that includes message data based on the extract symbols from the transformed packets received from the transceiver. In some examples, data assembler 560 can be configured to assemble a first portion of the symbols to establish a portion of the message that establishes a network connection with, for example, a server configured to stream media (e.g., a service, such as Spotify™ and the like). Further, data assembler 560 can be configured to assemble a second portion of the symbols to yield another message portion, whereby the second portion of symbols is configured to establish a bidirectional communication path between the receiving and transmitting devices. In this way, the transmitting device can receive confirmation of the receipt of its message data transmitted over the overlay communication channel. In some cases, extracted symbols can be stored as packet data 542 until such time that data assembler 560 can aggregate the extracted symbols to form message data, such as set forth in message data 570.

Message data 570 can be provided further to a data processor 580, which can include a media processor 582 in a communication processor 586. In one example, media processor 582, responsive to message data 570, can transmit a request 583 to a third-party media-streaming entity via network 584. Access to the third-party entity can be provided as part of message data 570. Thus, the third-party media-streaming entity can provide streaming media 585 for presentation as audio or video at, for example, a media device in which packet characteristic demodulator 546 and data processor 580 reside. In another example, communications processor 586, responsive to message data 570, can generate an acknowledgment or confirmation message 588 for transmission back to the transmitting device to confirm receipt of the transformed packets.

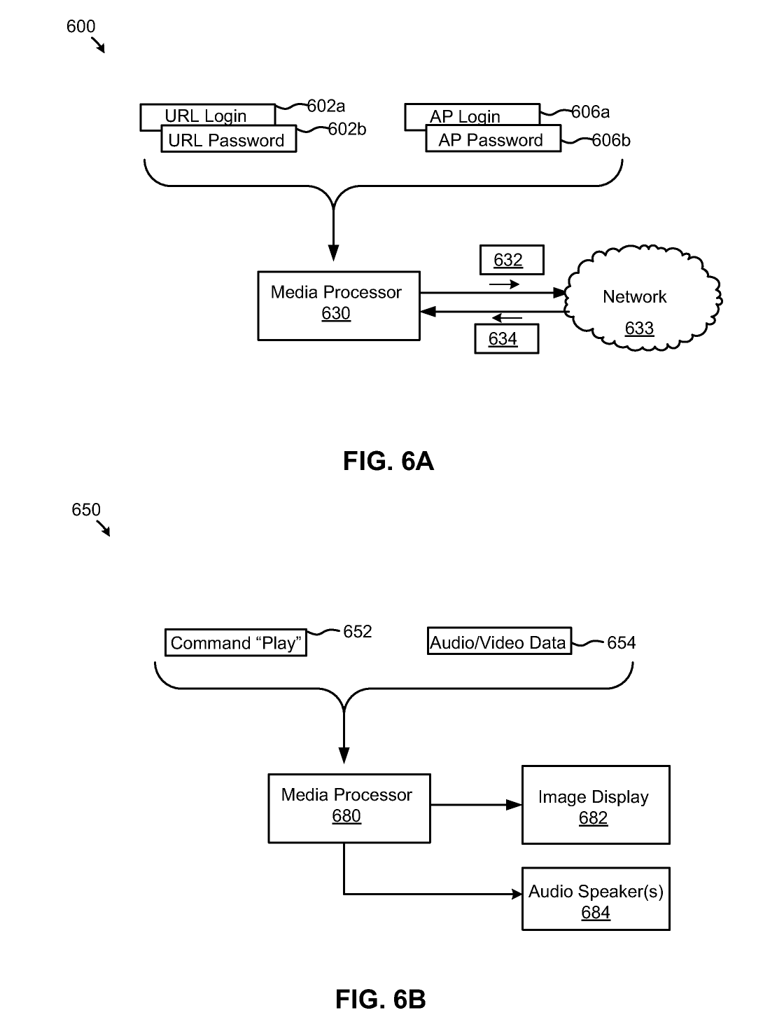

FIGS. 6A and 6B illustrate various functionalities of a media processor, according to some embodiments. Diagram 600 of FIG. 6A depicts media processor 630 configured to receive symbols that constitute message portions, such as a URL login 602a, a URL password 602b, an access point (“AP”) login 606a, and an access point (“AP”) password 606b. Responsive to receiving the aforementioned symbols and message portions, media processor 630 can use access point login 606a and access point password 606b to gain access to an access point (or router) to establish network connections to a third-party media streaming entity via network 633. Media processor can use URL login 602a and URL password 602b, as part of a request 632, to access an account, playlist, or other audio or video data from which streaming media 634 can be received back to media processor 630 for presentation to a user.

Diagram 650 of FIG. 6B depicts media processor 680 configured to receive symbols that constitute message portions, such as a command 652 and audio/video data 654. Media processor 680 is configured to receive command 652 and data 654, and, in response, can perform command 652 (e.g., a “Play” media command) in which data 654 is used to present one or more images of an image display 682, or audio via audio speaker 684. In some cases, audio data 654 can reside in memory of a mobile computing device that initiated formation of the overlay communication channel, whereby a recipient media device accesses that mobile computing device to consume media content for presentation.

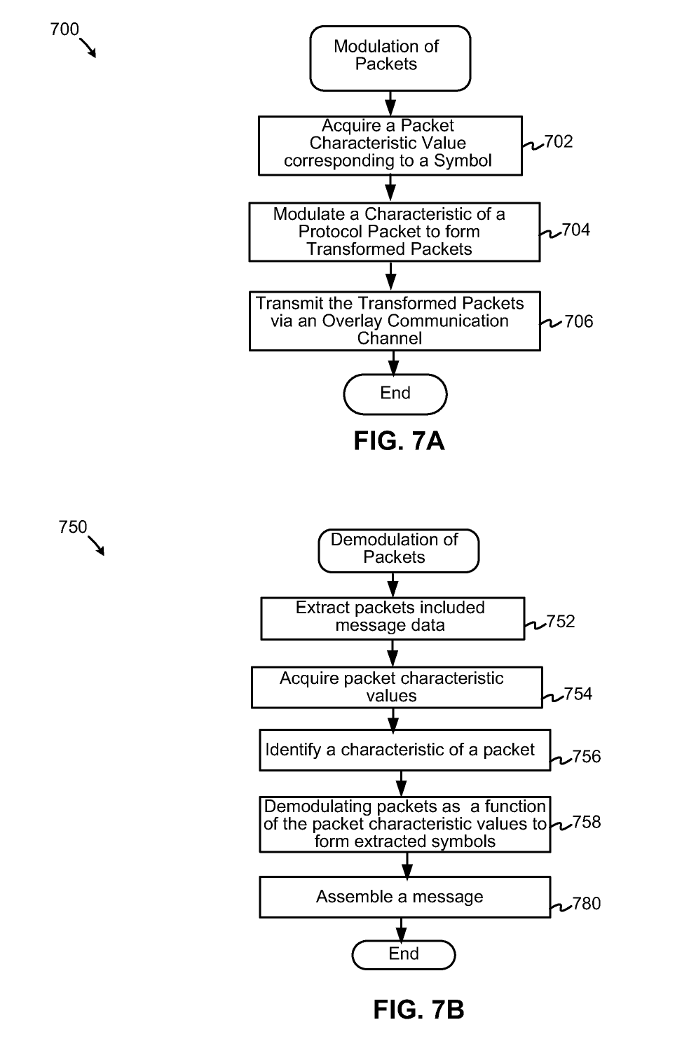

FIGS. 7A and 7B illustrate examples of modulating and demodulating packets and associated data, according to some embodiments. Flow 700 of FIG. 7A is an example flow for modulating packets and/or packet data, according to some embodiments. Flow 700 can begin at 702 with acquiring one or more packet characteristic values corresponding to one or more symbols. At 704, a packet characteristic is modulated (e.g., for packets associated with the symbols) to form transformed packets. In some embodiments, the packet characteristic that is modulated is publicly accessible. In one example, a packet characteristic that is modulated is the packet length of packets. At 706, the transformed packets are transmitted via an overlay communication channel.

Flow 750 of FIG. 7B is an example flow of demodulating packets and packet data, according to some embodiments. Flow 750 can begin at 752 with the extraction of packets that include message data. At 754, packet characteristic values are acquired, for example, from a repository. At 756, a characteristic of a packet is identified. For example, packet length can be identified as the characteristic of the packets to which demodulation is applied. At 758, extracted symbols are formed by demodulating packets as a function of the packet characteristic values. At 780, message data is assembled from the demodulated packet data.

In various embodiments, a mobile device including a packet characteristic modulator, such as a mobile phone or computing device, can be in communication (e.g., wired or wirelessly) with a media device including a packet characteristic demodulator. In some cases, such a mobile device, or any networked computing device (not shown) in communication with the media device, can provide at least some of the structures and/or functions of any of the features described herein. As depicted in FIG. 1 and subsequent figures (or preceding figures), the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 1 (or any figure) can represent one or more algorithms. Or, at least one of the elements can represent a portion of logic including a portion of hardware configured to provide constituent structures and/or functionalities.

For example, a packet characteristic demodulator (or modulator) and any of its one or more components, such as packet extractor 520, overlay data extractor 522, repository 530, repository 540, and data assembler 560 of FIG. 5 (or other FIGS.) can be implemented in one or more computing devices (i.e., any audio-producing device, such as desktop audio system (e.g., a Jambox® implementing LiveAudio® or a variant thereof), mobile computing device, such as a wearable device or mobile phone (whether worn or carried), that include one or more processors configured to execute one or more algorithms in memory. Thus, at least some of the elements in FIGS. 1, 2, and/or 5 (or any other figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, packet characteristic demodulator (or modulator) and any of its one or more components, such as packet extractor 520, overlay data extractor 522, repository 530, repository 540, and data assembler 560 of FIG. 5 (or other FIGS.) can be implemented in one or more computing devices that include one or more circuits.

Thus, at least one of the elements in FIGS. 1, 2, and 5 (or any other figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

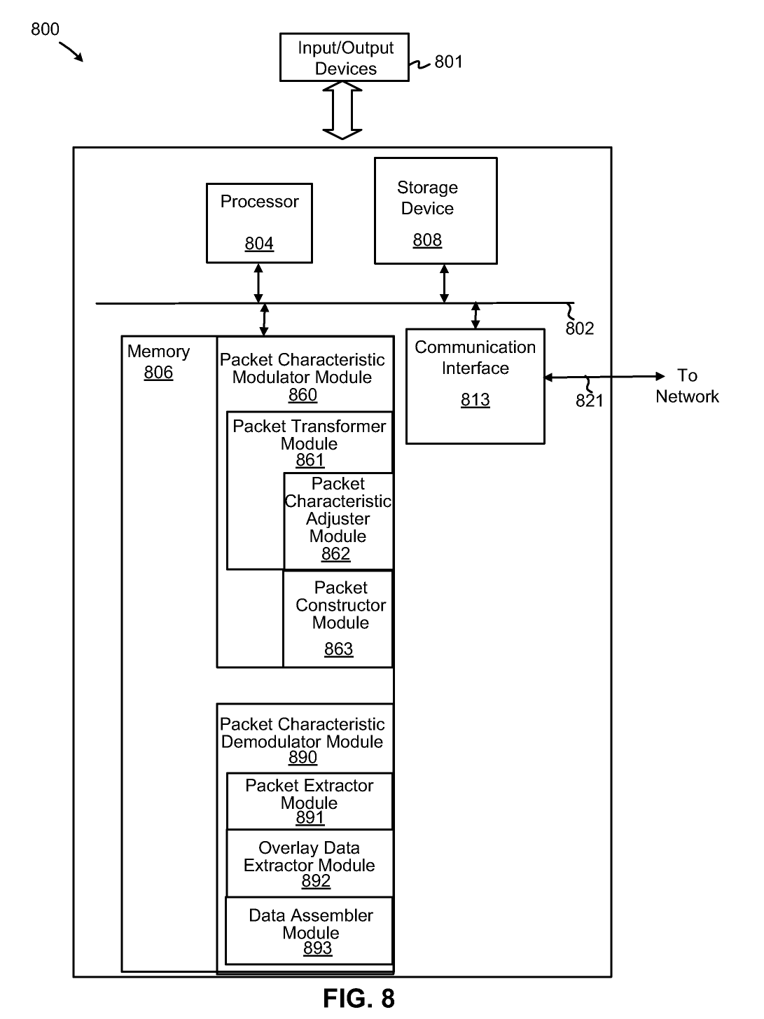

FIG. 8 illustrates an exemplary computing platform disposed in a media device, mobile device, or any computing device, according to various embodiments. In some examples, computing platform 800 may be used to implement computer programs, applications, methods, processes, algorithms, or other software to perform the above-described techniques. Computing platform 800 includes a bus 802 or other communication mechanism for communicating information, which interconnects subsystems and devices, such as processor 804, system memory 806 (e.g., RAM, etc.), storage device 808 (e.g., ROM, etc.), a communication interface 813 (e.g., an Ethernet or wireless controller, a Bluetooth controller, etc.) to facilitate communications via a port on communication link 821 to communicate, for example, with a computing device, including mobile computing and/or communication devices with processors. Processor 804 can be implemented with one or more central processing units (“CPUs”), such as those manufactured by Intel® Corporation, or one or more virtual processors, as well as any combination of CPUs and virtual processors. Computing platform 800 exchanges data representing inputs and outputs via input-and-output devices 801, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 800 performs specific operations by processor 804 executing one or more sequences of one or more instructions stored in system memory 806, and computing platform 800 can be implemented in a client-server arrangement, peer-to-peer arrangement, or as any mobile computing device, including smart phones and the like. Such instructions or data may be read into system memory 806 from another computer readable medium, such as storage device 808. In some examples, hard-wired circuitry may be used in place of or in combination with software instructions for implementation. Instructions may be embedded in software or firmware. The term “computer readable medium” refers to any tangible medium that participates in providing instructions to processor 804 for execution. Such a medium may take many forms, including but not limited to, non-volatile media and volatile media. Non-volatile media includes, for example, optical or magnetic disks and the like. Volatile media includes dynamic memory, such as system memory 806.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 802 for transmitting a computer data signal.

In some examples, execution of the sequences of instructions may be performed by computing platform 800. According to some examples, computing platform 800 can be coupled by communication link 821 (e.g., a wired network, such as LAN, PSTN, or any wireless network) to any other processor to perform the sequence of instructions in coordination with (or asynchronous to) one another. Computing platform 800 may transmit and receive messages, data, and instructions, including program code (e.g., application code) through communication link 821 and communication interface 813. Received program code may be executed by processor 804 as it is received, and/or stored in memory 806 or other non-volatile storage for later execution.

In the example shown, system memory 806 can include various modules that include executable instructions to implement functionalities described herein. In the example shown, system memory 806 can include a packet characteristic modulator module 860 that includes a packet transformer module 862, which includes a packet characteristic adjuster module 862, and a packet constructor module 863. Alternatively, system memory 806 can include a packet characteristic demodulator module 890, a packet extractor module 891, an overlay data extractor module 892, and a data assembler module 893.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method comprising:
receiving an instruction to transmit transformed packets including message data via a radio transmitter to form an overlay communication channel;
acquiring a subset of the packet characteristic values to encode the message data, each of the packet characteristic value corresponding to a symbol;
modulating at a processor a characteristic of packets specified by a network protocol as a function of the subset of the packet characteristic values to form the transformed packets; and
transmitting the transformed packets via the overlay communication channel.

2. The method of claim 1, wherein modulating the characteristic of the packet comprises:
modifying an accessible characteristic.

3. The method of claim 2, wherein modifying the accessible characteristic comprises:
modifying non-encrypted data representing the characteristic of the packets.

4. The method of claim 1, wherein modulating the characteristic of the packet comprises:
modifying packet lengths of the packets in accordance with the subset of the packet characteristic values; and
encoding symbols corresponding to the subset of the packet characteristic values into the packets to form the transformed packets.

5. The method of claim 1, further comprising:
identifying symbols constituting the message data that is configured to cause a media device to perform a media-related operation;
accessing at a repository symbol transformation data including associations between each of the symbols and a corresponding packet characteristic value; and
retrieving the corresponding packet characteristic value to modulate the characteristic of one of the packets.

6. The method of claim 1, further comprising:
acquiring another subset of packet characteristic values associated with control symbols that constitute data representing one or more of a command, application data, and an overlay checksum based on symbols encoded into the packets that form the transformed packets.

7. The method of claim 1, wherein receiving the instruction to transmit the transformed packets comprises:
receiving data representing a password and an operation to initiate presentation of audio and/or video.

8. A method comprising:
receiving packets at a radio receiver of a first device from an overlay communication channel, the packets originating from a second device;
extracting from the packets a subset of the packets including message data;
acquiring a subset of the packet characteristic values to determine the message data, each of the packet characteristic values corresponding to a symbol;
identifying a characteristic of the subset of the packets specified by a network protocol;
demodulating at a processor the subset of the packets as a function of the subset of the packet characteristic values to form extracted symbols;
assembling a message including the message data based on the extracted symbols; and
causing presentation of audio and/or video in accordance with the message.

9. The method of claim 8, wherein receiving the packets at the first device comprises:
receiving the subset of the packets unidirectionally from the second device to the first device independent of authorization data that establishes a session between the first device and the second device,
wherein the overlay communication channel facilitates autonomous discovery of the first device.

10. The method of claim 8, wherein demodulating the characteristic of the packet comprises:
identifying an accessible characteristic.

11. The method of claim 10, wherein identifying the accessible characteristic comprises:
identifying non-encrypted data representing the characteristic of the packets.

12. The method of claim 8, wherein demodulating the characteristic of the packet comprises:
identifying packet lengths of the packets, the packet lengths being the packet characteristic values; and
decoding the packet lengths to form the extracted symbols.

13. The method of claim 8, wherein extracting the subset of the packets comprises:
detecting the subset of packets formatted in accordance with a ping protocol.

14. The method of claim 8, wherein assembling the message comprises:
assembling a portion of the symbols to form a password and data defining presentation of the audio and/or the video.

15. The method of claim 8, further comprising:
identifying packet lengths of the packets;
accessing from a repository symbol inverse transformation data including associations between each of the symbols and a corresponding packet characteristic value; and
retrieving the corresponding packet characteristic value to demodulate the characteristic of one of the packets.

16. The method of claim 8, wherein assembling the message comprises:
assembling a first portion of the symbols to establish a network connection with a server configured to stream media; and
assembling a second portion of the symbols to establish another network connection between the first device and the second device.

17. A system comprising:
a device comprising:
a transceiver configured to at least receive radio frequency communication signals including packets;
a memory including a protocol stack including data representing communication protocol requirements; and
a packet characteristic demodulator processor including:
a packet extractor configured to extract a subset of the packets including message data from the packets;
a repository including packet characteristic values configured to determine the message data, each of the packet characteristic values corresponding to a symbol;
an overlay data extractor configured to acquire the packet characteristic values, to identify a characteristic of the subset of the packets specified by the protocol stack, and to extract symbols from the subset of the packets as a function of the characteristic to form extract symbols; and
assembling a message including the message data based on the extract symbols; and
a data processor configured to perform an operation in accordance with the message.

18. The system of claim 17, wherein the device is a media device configured to present audio and/or video responsive to performance of the operation.

19. The system of claim 17, further comprising:
another device comprising:
a packet characteristic modulator processor including:
a packet transformer configured to transform the packets including the symbols into transformed packets, the packet transformer including:
a packet adjuster configured to modulate values of the characteristic of the subset of the packets to encode the symbols into the transformed packets; and
a packet constructor configured to construct the transformed packets in accordance with another protocol stack.

20. The system of claim 19, wherein the another device is a mobile communication device configured to facilitate transmission of personal data as the message data.
